(19) United States
(12) Patent Application Publication
(10) Pub. No.: US 2018/0010624 A1
(43) Pub. Date: Jan. 11, 2018

(54) CONNECTION SYSTEMS FOR FRAMEWORK

(71) Applicant: David Schlitter, Pendleton, SC (US)

(72) Inventor: David Schlitter, Pendleton, SC (US)

(21) Appl. No.: 15/202,697

(22) Filed: Jul. 6, 2016

(51) Int. Cl. F16B 12/40; A47B 13/00; F16B 7/04; A47C 4/02; A47B 13/08

(52) U.S. Cl. CPC F16B 12/40; A47C 4/02; A47B 13/083; F16B 7/0486; F16B 7/0426; A47B 13/003; A47B 2013/006; F16B 2012/403

(57) ABSTRACT

Connectors for assembling off-the-shelf framework such as pipes and tubes. The connectors include parts that can have puzzle-shaped ends for locking the components together, and when connected, the connectors form various cavities that may include friction-inducing components disposed in the cavities to render the framework stationary. The cavities may be sized to accommodate different sizes of framework.

### BACKGROUND

Pipes, beams, and other framework are connected typically with nails, bolts, welds, and specialized fittings. However, conventional connectors suffer from various drawbacks such as being restricted to compatible framework based on connector size and type of material. The known connectors also usually require specialized tools and experience to assemble. Moreover, conventional connectors are difficult, if not impossible, to disconnect in order to reuse the connectors and the framework to assemble a different item.

What is needed in the industry is a flexible connector system that can be used with a variety of framework and can be connected and disconnected without requiring specialized tools or knowledge.

### BRIEF SUMMARY OF THE DISCLOSURE

The present disclosure is directed to connector systems for assembling tubes, pipes, conduits, and other framework to create a variety of items such as tables, bike stands, racks, umbrellas, chairs, and the like. The systems described in detail herein are simple and economical to manufacture and to use.

According to one embodiment of the disclosure, a connector for assembling components may include a first part having a first proximal end and a first distal end, at least one of the first ends having a first non-linear edge; a second part having a second proximal end and a second distal end, at least one of the second ends having a second non-linear edge complementary to the first non-linear edge for mating therewith, wherein, when the first part and the second part are mated, a cavity is formed therebetween to receive framework; a friction-inducing component disposed in the cavity, the friction-inducing component being configured to render the framework stationary; and locking means to lock the first and second part together. The first and the second non-linear edges may be puzzle-shaped. The friction-inducing component may be an end-cap, a shrink-wrap, a cavity coating and/or a friction insert. The cavity coating may be an elastomeric material affixed within the cavity. The friction insert may have a desired thickness and a shape complementary to the framework such that the friction insert sizes the cavity to complement the framework. Also in this embodiment, the locking means may be a screw, a bolt, a snap-fit and the like.

In another embodiment, a connector for assembling components may include a first part having a first proximal end, a first distal end, and a concave joining element disposed therebetween; a second part having a second proximal end, a second distal end, and a convex joining element disposed therebetween, wherein, when the first part and the second part are mated, a cavity is formed between concave and convex joining elements to receive a pipe; a friction-inducing component disposed between the cavity and the pipe, the friction-inducing component being configured to render the pipe stationary; and locking means to lock the first and second part together. The friction-inducing component may be an end-cap, a shrink-wrap, a cavity coating, and/or a friction insert. The locking means may be a screw, a bolt, a snap-fit, a latch, and/or a catch. For instance, the locking means may have a tab and a receptacle, the tab being configured to lock in the receptacle.

In another embodiment, a connector for assembling components may include one or more first parts each having a first proximal end and a first distal end; one or more second parts each having a second proximal end and a second distal end, the second ends being complementary to the first ends for mating therewith wherein, when the first parts and the second parts are mated, respective cavities are formed therebetween to receive at least one workpiece therein; a friction-inducing component disposed in at least one of the cavities, the friction-inducing component being configured to adjust a size of the mated first and second parts to press-fit the workpiece therebetween and to render the workpiece stationary; and an attachment mechanism being configured to lock the plurality of first and second parts together. At least one of the first ends and at least one of the second ends may have respective non-linear edges, which are substantially mirror images of each other and configured to hold the first and second ends together. At least one of the first ends and at least one of the second ends may have respective puzzle-shaped ends being substantially mirror images of each other and configured to hold the first and second ends together. Additionally, or alternatively, at least one of the first ends and at least one of the second ends may be hinged together. At least one of the first ends and at least one of the second ends may be parallel to each other. Alternatively, at least one of the first ends and at least one of the second ends may be angled to each other.

The friction-inducing component in this embodiment may include shrink-wrap, ribs, a sleeve, and/or an endcap. The attachment mechanism may be a bolt and nut and/or tab and receptacle combinations and/or complementary, opposing latches. The attachment mechanism can include a button to release the tab from the receptacle or an aperture to release the latches.

Additional aspects of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of such variations upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of one embodiment of a connector system in an intended use environment according to the present disclosure;

FIG. 2 is a detailed view of the connector system as in FIG. 1;

FIG. 3 is an exploded, perspective view of the connector system as in FIG. 1;

FIG. 4 is an assembled, perspective view the connector system as in FIG. 3, particularly showing another connector system from a different perspective;

FIG. 5 is a perspective view of another embodiment according to the disclosure;

FIG. 6 an exploded, perspective view of the connector system as in FIG. 3, particularly showing two components being assembled or disassembled;

FIG. 7 is a perspective view of the connector system as in FIG. 6, particularly showing a further stage of assembly or disassembly;

FIG. 8 is a perspective view of the embodiment as in FIG. 6, particularly showing another stage of assembly or disassembly; and

FIG. 9A is a perspective view of the embodiment as in FIG. 6, particularly showing another stage of assembly or disassembly;

FIG. 9B is a perspective view of the embodiment as in FIG. 9A, particularly showing another stage of assembly or disassembly;

FIG. 9C is a perspective view of the embodiment as in FIG. 9A, showing an alternate stage of assembly or disassembly relative to FIG. 9B;

FIG. 10 is a perspective, end view of the embodiment as in FIG. 3 in a partially assembled state;

FIG. 11 is a perspective, exploded, comparative view of various embodiments according to the disclosure;

FIG. 12 shows perspective, comparative views of various embodiments according to the disclosure, including the assembled embodiment of FIG. 3;

FIG. 13 shows an exploded, perspective view of a connector system according to another embodiment of the disclosure, particularly showing two components being assembled or disassembled;

FIG. 14 is a perspective view of another embodiment according to the disclosure, particularly showing a stage of assembly of this aspect of the disclosure;

FIG. 15 is a perspective view of the embodiment as in FIG. 14, particularly showing an assembly step;

FIG. 16 is an exploded, perspective view of another embodiment according to the disclosure, particularly showing installation of inserts; and

FIG. 17 is an exploded view of another embodiment according to the disclosure, particularly showing various perspectives thereof.

### DETAILED DESCRIPTION

Detailed reference will now be made to the drawings in which examples embodying the present subject matter are shown. The detailed description uses numerical and letter designations to refer to features of the drawings.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents.

Although detailed embodiments are disclosed as required, it is to be understood that the embodiments are merely exemplary. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the various embodiments of the present disclosure.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Wherever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etcetera. Thus, for example, “a device having components a, b, and c” means that the device includes at least components a, b and c. Similarly, the phrase: “a method involving steps a, b, and c” means that the method includes at least steps a, b, and c.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

While terms such as “first,” “second,” “third,” and “fourth” are used to identify various components of various embodiments, unless otherwise stated in the context in which those terms are utilized, such terms are simply an arbitrary naming convention to distinguish between pieces and parts. For instance, a “first half” and a “second half” are not limited relative to each other in importance nor chronologically. The “first half” could just as well be called the “second half” and vice versa.

Any discussion of prior art in the specification should in no way be considered as an admission that such prior art is widely known or forms part of common general knowledge in the field.

The various embodiments of the disclosure and/or equivalents falling within the scope of present disclosure overcome or ameliorate at least one of the disadvantages of the prior art, or provide a useful alternative.

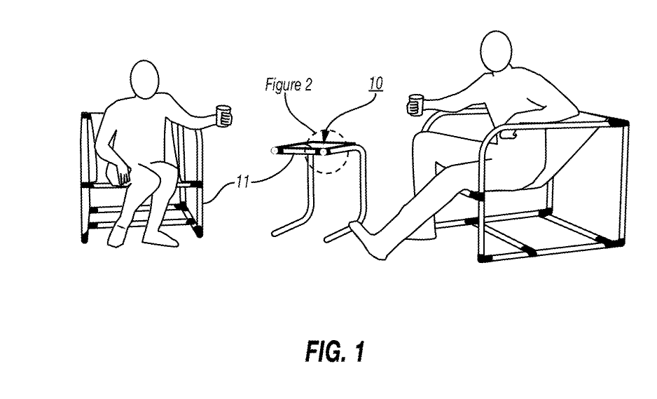

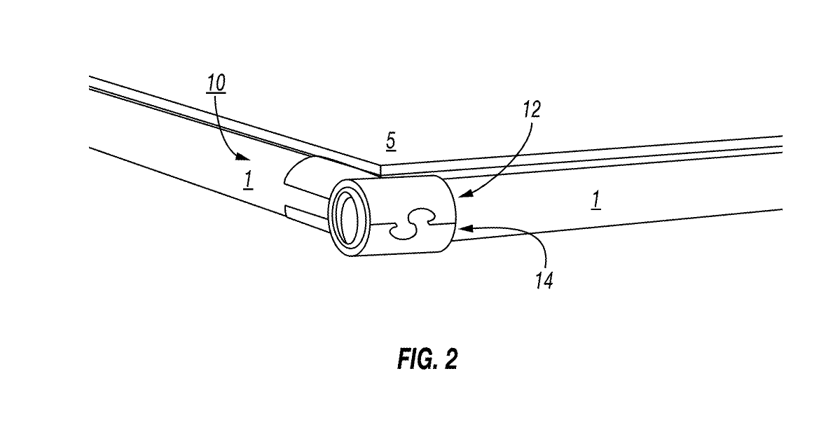

Turning now to the figures, FIG. 1 shows a connector or connection system designated in general by the reference number 10. Here, the connection system 10 is used to create chairs and a table, generally designated by element number 11, but the system 10 can also be used for stands, umbrellas, bicycle racks and a variety of useful articles. The articles 11 can be made using off-the-shelf tubing, pipes, rods, conduits, electrical metallic tube (EMT), and the like. See, e.g., FIG. 2. Also, although the exemplary connection system 10 is shown being used with tubular or cylindrical shaped conduits, other variations may include angular or square-shaped components for use with similarly shaped off-the-shelf framework.

FIG. 2 most clearly shows the connection system 10, which is bifurcated and includes a first half, part, sleeve or jacket 12, and a second half, part, sleeve or jacket 14 in this example. As shown, the off-the-shelf tubes, generally designated by element number 1, are squeeze-fitted between the sleeves 12, 14 to form a frame or platform for holding a glass top 5. Also in this example, the connection system 10 is arranged to orient two of the off-the-shelf tubes 1 substantially orthogonally or at right angles to one another. Additional details of the connection system 10 and an exemplary process of joining the sleeves 12, 14 to the tubes 1 are described in greater detail below.

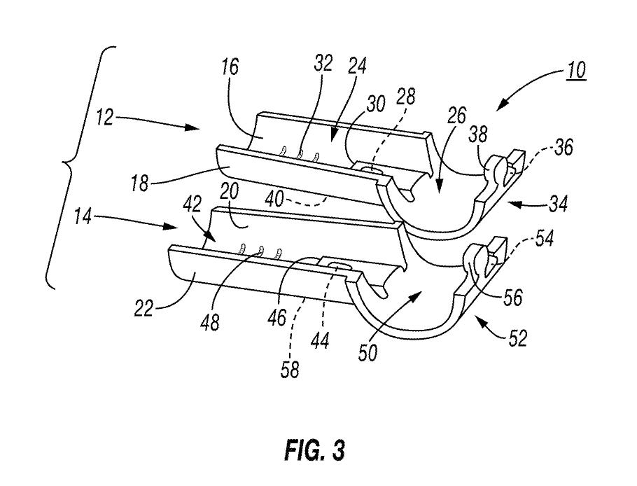

With reference to FIG. 3, the parts 12, 14 are shown separated. Although the parts 12, 14 appear substantially identical and bifurcated in this example, the disclosure is not limited to bifurcation or to the parts 12, 14 being of equal size. For instance, one part 12, 14 could be longer than the other in order to accommodate a desired bend in a workpiece, or one of the parts 12, 14 could be deeper than the other part and one part shallower.

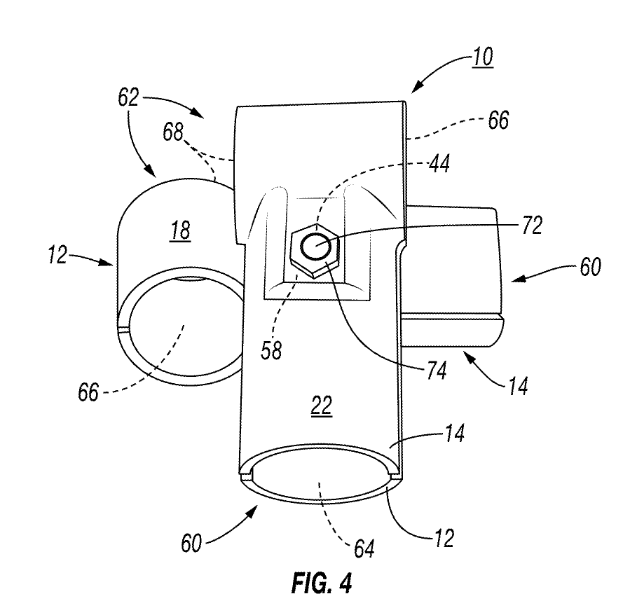

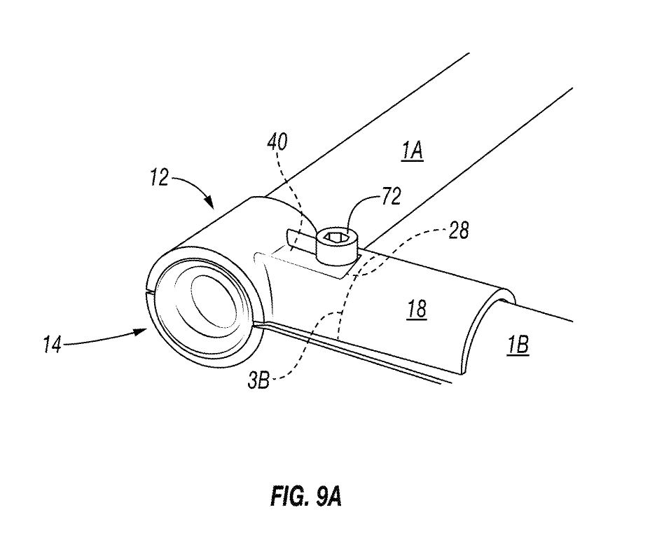

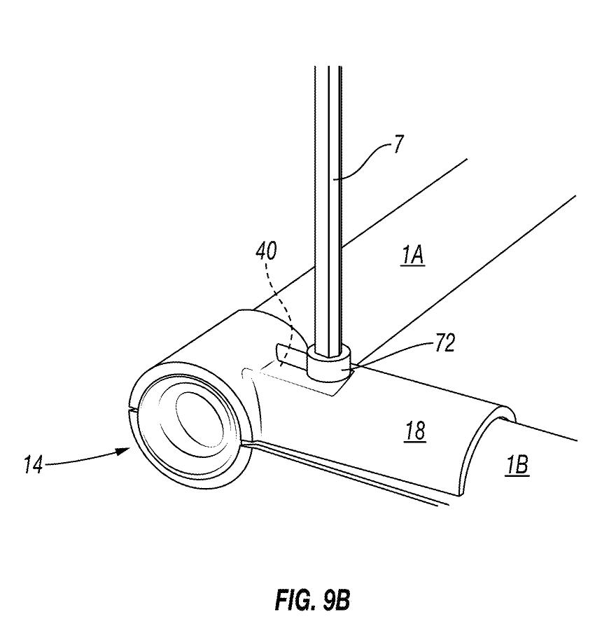

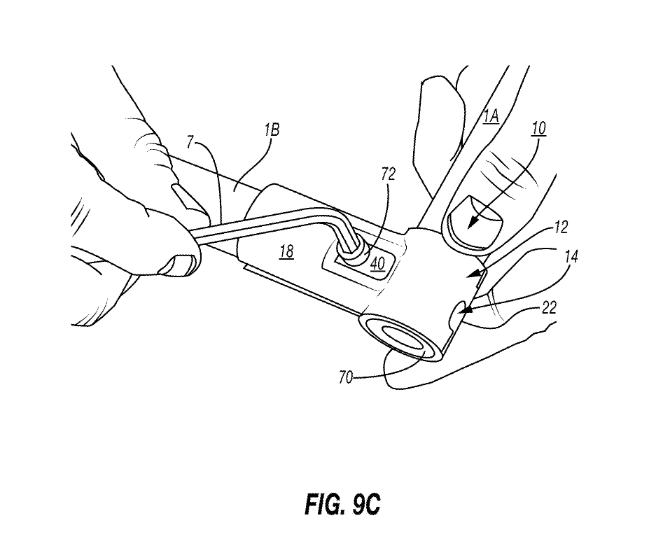

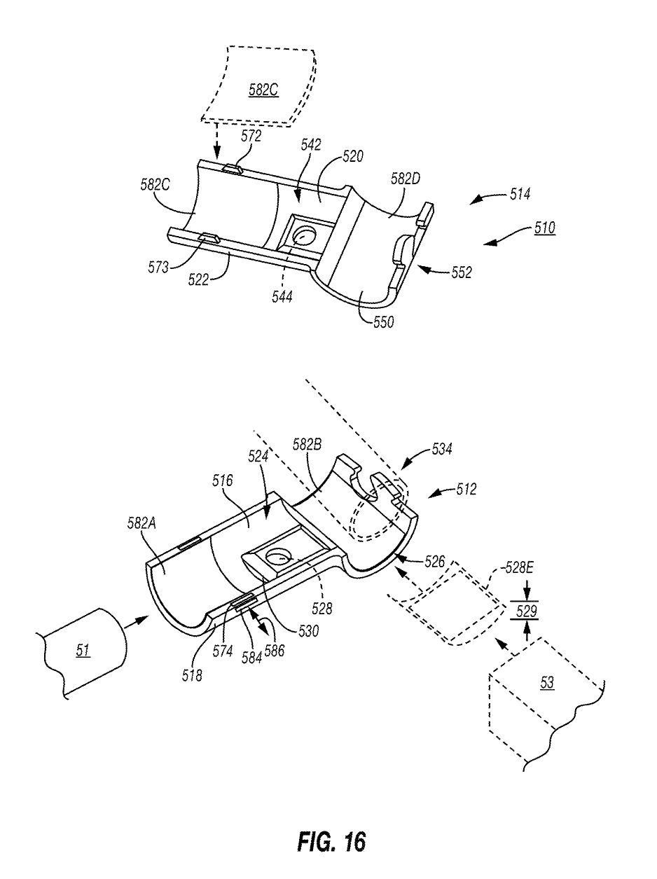

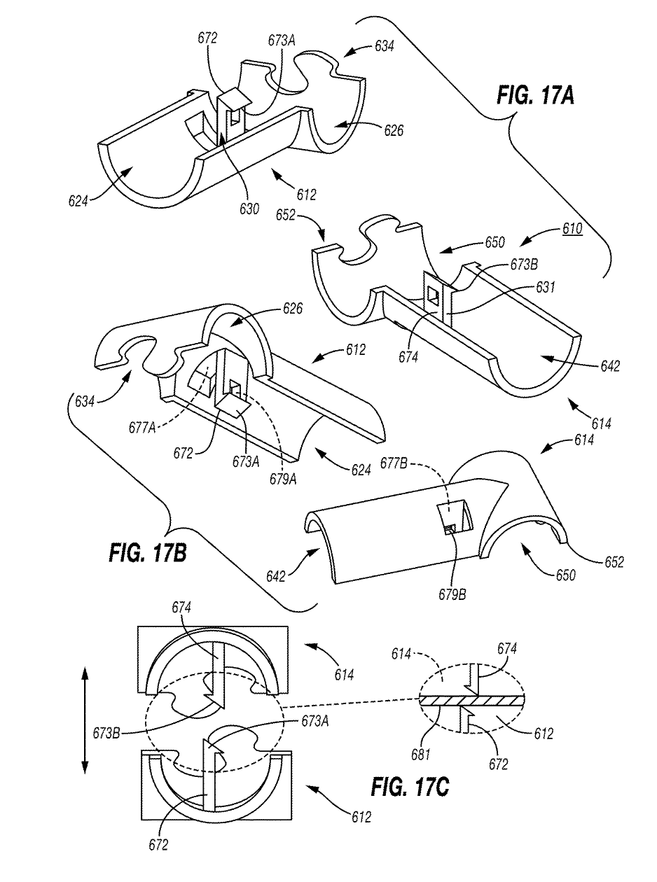

Continuing with reference to FIG. 3, the first half 12 may include a first inner or interior wall or face 16, which is substantially concave or C-shaped in end view. Opposite the first face 16 is a first outer or exterior wall or face 18 having a recess or pocket 40. The first face 16 may form a first cradle, cup, or raceway 24 having a first aperture or hole 28, a first stop, berm, or ledge 30, and one or more point bearing surfaces such as ridges or ribs 32. The aperture 28 is for insertion of an attachment mechanism, such as a hex bolt, Cotter key, pin, screw or the like. See, e.g., attachment mechanism 72, 74 in FIGS. 4, 9A, mechanism 572 in FIG. 16, and devices 672, 674 in FIG. 17. The recess 40 will seat or lower a profile of the attachment mechanism, or a corresponding nut, viewed from a side of the face 18. Also shown here, the berm 30 serves to limit axially insertion of a workpiece, and the ribs 32 help to grip or press-fit the workpiece within the parts 12, 14—example operations of which are described herein.

As the example of FIG. 3 further shows, the first interior wall 16 may define a second cradle, cup, or raceway 26 formed, attached, or connected substantially orthogonally to the first raceway 24. In other words, the raceways 24, 26 have different orientations, including but not limited to being normal to each other. Here, the raceway 26 includes a first terminal edge or end 34 that defines a first indentation or gap 36 and a first projection or protuberance 38. Although not limited to these examples, the indentation 36 and the protuberance 38 are substantially next to each other and may be mirror images of each other to receive similar complementary components as explained below.

With particular reference to the second half 14 shown in FIG. 3, an inner wall or face 20 has an opposing exterior or outer wall or face 22. Similar to the face 16 introduced above, the exemplary interior wall 20 is also substantially concave, or C-shaped in end view. The second face 20 may form a third cradle, cup, or raceway 42 having a second aperture or hole 44, a second stop, berm, or ledge 46, and one or more ribs or point bearing surfaces 48. The second aperture 44 is complementary to the first aperture 28 to receive the attachment mechanism introduced above. The aperture 44 extends through the interior wall 20 to the outer wall 22 and may include a second recess or pocket 58. Like the recess 40 noted above, the recess 58 seats, or lowers the profile of, the attachment mechanism viewed from a side of the face 22. Also like the berm 30 above, the berm 46 helps stop axial movement of the tube 1, and the ribs 48 help hold the tube 1 stationary within the parts 12, 14.

Also shown in FIG. 3, the second interior wall 20 may define a fourth cradle, cup, or raceway 50 formed, attached, or connected substantially orthogonally to the third raceway 42. As shown, the raceways 42, 50 may have different orientations, including but not limited to being normal to each other. Here, the raceway 50 includes a second terminal edge or end 52 that defines a second indentation or gap 54 and a second projection or protuberance 56. Although not limited to these examples, the indentation 54 and the protuberance 56 are substantially next to each other and are mirror images of each other to mate with their complementary counterpart indentation 36 and protuberance 38 introduced above. In other words, the first protuberance 38 will fit the second gap 54 and the second projection 56 will fit in the first indentation 36 to help lock the parts 12, 14 together.

Turning now to FIG. 4, there is shown in perspective the bifurcated parts 12, 14 locked or attached together to form the connection system 10. Here, the attachment mechanism 72, briefly introduced above, projects through the aperture 44, and the nut 74 is connected to or screwed onto the attachment mechanism 72. As shown, the attachment mechanism 72 and the nut 74 are recessed in the pocket 58 to be substantially flush with the outer surface 22. The pocket 58 may be sufficiently large to accommodate a width of the nut 74 to permit a wrench or other appropriate tool (not shown) to manipulate the nut 74 within the pocket 58. However, the attachment mechanism 72 is not limited to the foregoing arrangement. For instance, the pocket 58 may be sized to accommodate the nut 74 in a manner that the nut 74 is captive within the pocket 58 and does not require any tool to hold the nut 74 in place while being mated to the attachment mechanism 72. Moreover, the attachment mechanism 72 and the nut 74 could be reversed and attached from opposite sides such that the nut 74 is instead recessed in the pocket 40 of the outer wall 18 (see, e.g., FIG. 3). Also, although a screw and nut combination 72, 74 are shown by way of example, other attachments could also or alternatively be used, such as a quick release pin or a leaf-spring arrangement 574 as shown in FIG. 16.

Also, for ease of comparison, FIG. 4 shows two connection systems 10 in different relative positions. As shown, each of connection systems 10 have, when assembled, a first or distal end 60 and a second or proximal end 62. Each distal end 60 includes a first hole or receptacle 64 to receive an end of a conduit (see, e.g., tube 1 in FIG. 2). Each proximal end 62 forms a second hole, receptacle, or entry 66 and a third hole, receptacle, or entry 68 to receive a portion of a conduit (see, e.g., tube 1 in FIG. 2).

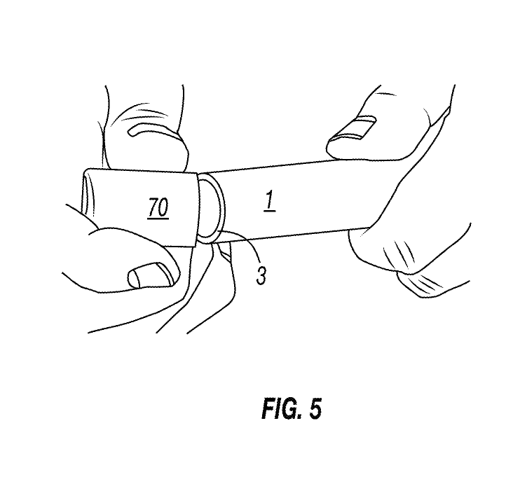

FIG. 5 shows another aspect of the disclosure, which includes an end-cap or cover 70 that may be made of elastomeric or thermoplastic material sized to fit an end of the pipe 1. The end-cap 70 serves at least two purposes. First, if the pipe 1 has been trimmed or cut to a desired length, it may have sharp edges, which the end-cap 70 will cover to prevent injury or damage. Second, the end-cap 70 can provide an additional gripping feature such that, when the distal end 60 of the connection system 10 as in FIG. 4 is clamped over the pipe 1 that is fitted with the end-cap 70, the pipe 1 will not slide out of, or rotate within, the connection system 10 due to the non-skid or anti-slippage characteristic of the end-cap 70. Additionally, or alternatively, non-skid material may be coated, sprayed, or inserted within the connection system 10 to provide added grip (see, e.g., friction insert 570 in FIG. 16).

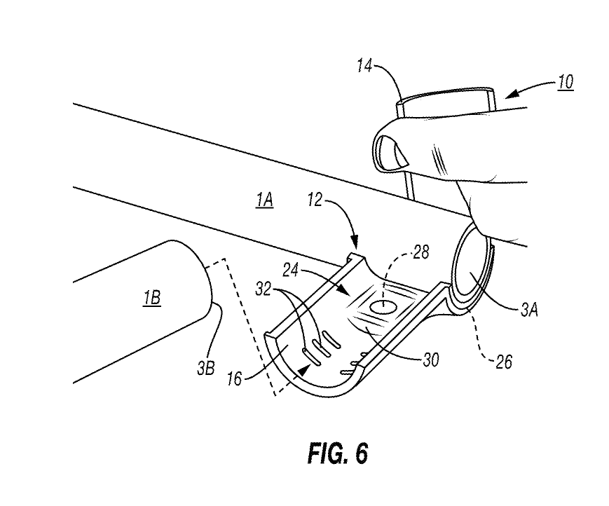

FIG. 6 shows an exemplary assembly procedure for the connection system 10. As shown, the first part 12 and the second part 14 are arranged with two pieces of conduit 1A, 1B. Here, a terminal end 3A of the conduit 1A is inserted in the raceway 26 of the first part 12. The second part 14 is shown being latched or drawn over the terminal end 3A in a direction of the first part 12. The other conduit 1B is shown about to be laid or inserted in the cradle 24 as indicated by the dashed arrow. The aperture 28 is clearly shown next to the ledge 30, which are near the ribs 32. Once the conduit 1B is inserted to the ledge 30, its terminal end 3B can go no farther; in other words, the terminal end 3B will not interfere with the aperture 28.

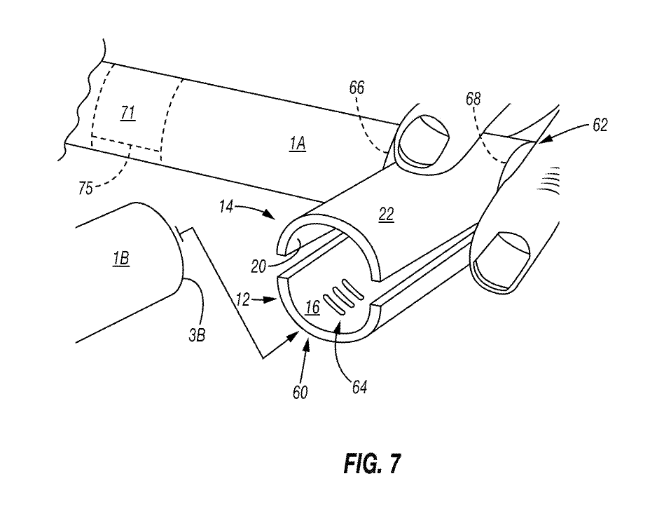

In FIG. 7 the exemplary assembly procedure for the connection system 10 continues with the first part 12 and the second part 14 being closed about the conduit 1A, which is held in the proximal end 62 through the second hole 66 but in this example does not extend beyond the third receptacle 68. Also shown, the terminal end 3B of the other conduit 1B is being inserted in the distal end 60 of the connection system 10 and is formed by closing the first part 12 and the second part 14 together. More particularly, the conduit 1B is inserted into the receptacle 64, which clearly shows the first and second inner walls 16, 20. Also shown, the ribs 32 are spaced apart on the inner wall 16, which will be pressed against the terminal end 3B to render the conduit 1B stationary.

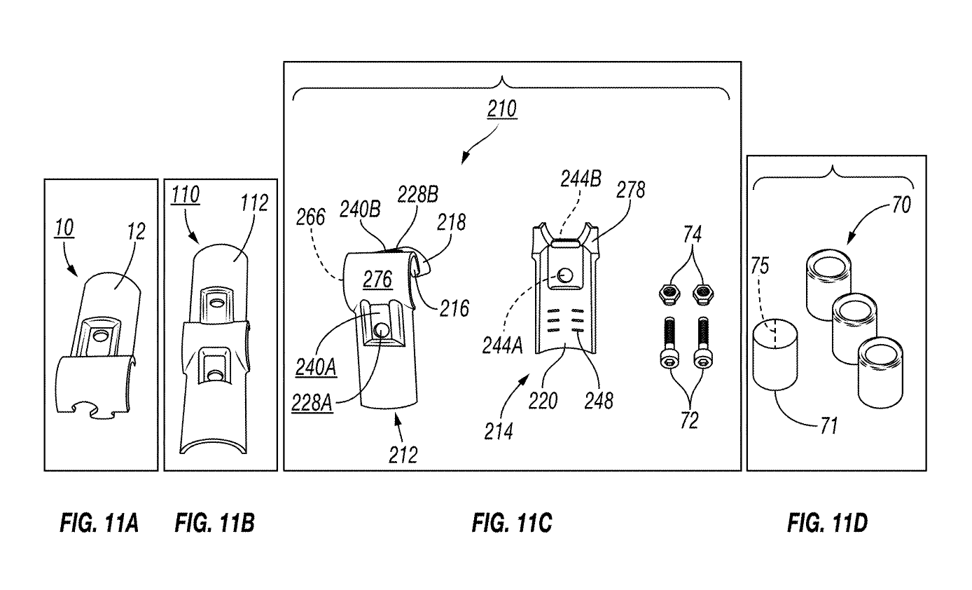

By way of further example, FIG. 7 shows in phantom for clarity a removable friction piece or sleeve 71. The sleeve 71, which may be elastomeric, can provide grip for another connection system (see, e.g., system 110 in FIG. 11) for utilization at a midsection or other intermediate portion of the pipe 1A. In this regard, the sleeve 71 may include an opening or slit 75 so that the sleeve 71 can be pulled apart and placed at any point on the pipe 1A rather than sliding the sleeve 71 from an end of a workpiece. Once installed on the pipe 1A, the sleeve 71 will return to original form, and its non-skid or anti-slip character will prevent the pipe 1A from sliding out of, or rotating within, a connection system used according to the disclosure.

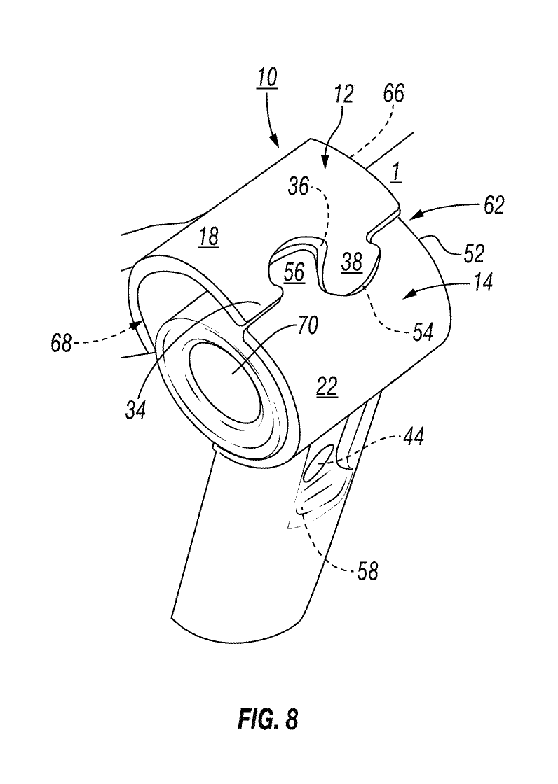

Another aspect of the exemplary assembly procedure for the connection system 10 is shown in FIG. 8. As shown, the end-cap 70 has been fitted onto the tube 1, which has been inserted through opening 66 and substantially terminates at opening 68 of the first proximal end 62. Most clearly shown are the first and second terminal ends 34, 52 of respective first and second parts 12, 14. As introduced above with respect to FIG. 3, the first terminal end 34 includes the first indentation 36 and the first projection 38 extending from surface 18. The second terminal end 52 includes the second indentation 54 and the second projection 56 extending from surface 22, which also clearly shows the previously introduced aperture 44 and the recess 58.

FIG. 8 further shows that the first protuberance 38 is slipped into the second gap 54 and the second projection 56 slips into the first indentation 36. Accordingly, the parts 12, 14 grab or grip each other to prevent slippage relative to each other. The indentations 36, 54 and the projections 38, 56 also act like a hinge and vice combination to squeeze around the end-cap 70 and the tube 1. Although the first, second indentations 36, 54 and the first, second projections 38, 56 appear next to each other and are non-linear or puzzle-shaped in this example, the disclosure contemplates fewer or additional indentations and projections, which can also be sized differently and/or spaced farther apart from each other.

Turning to FIG. 9A, the connection system 10 is shown with the first part 12 and the second part 14 closed about both pieces of the conduit 1A, 1B. As shown in phantom, the terminal end 3B of the conduit 1B stops at or about the aperture 28 through which the hex bolt 72 extends. As introduced above, the hex bolt 72 is recessed at least partially from the surface 18 within the pocket 40 to reduce its profile.

FIG. 9B, like FIG. 9A, shows the first part 12 and the second part 14 of the connection system 10 being tightened about both pieces of the conduit 1A, 1B. As shown, a tool 7 such as a screwdriver can be used to tighten (or loosen) the hex bolt 72.

FIG. 9C, like FIG. 9B, shows the first part 12 and the second part 14 of the connection system 10 being tightened about both pieces of the conduit 1A, 1B, which in this example, includes the end cap 70. Here, the tool 7 is an Allen wrench or hex key for tightening (or loosening) the hex bolt 72 from a side of the surface 18 in a direction of the surface 22, although the parts and direction could be reversed.

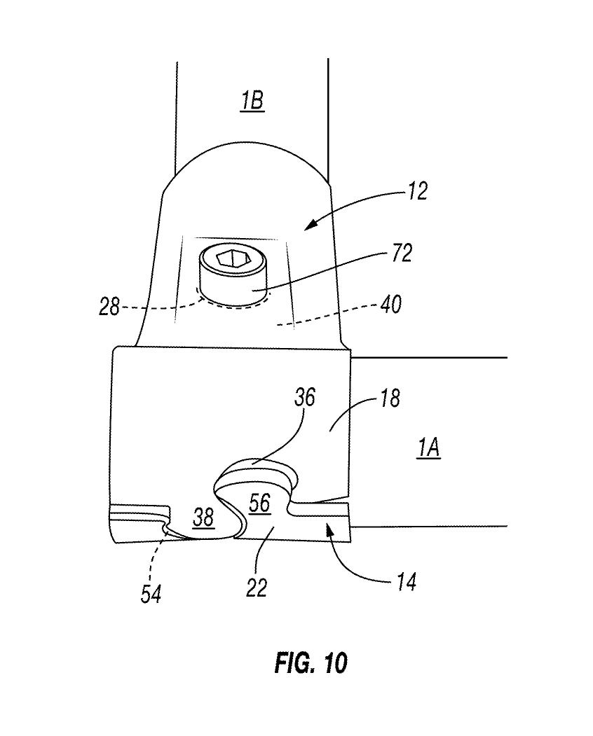

FIG. 10 most clearly shows the puzzle-shaped perspective of the exemplary parts 12, 14, similar to FIG. 8, in which the first protuberance 38 from the surface 18 is locked into the second gap 54 of the surface 22, and the second projection 56 is locked into the first indentation 36 about pieces of conduit 1A, 1B. Again, the hex bolt 72 is seated through the aperture 28 and recessed in the pocket 40.

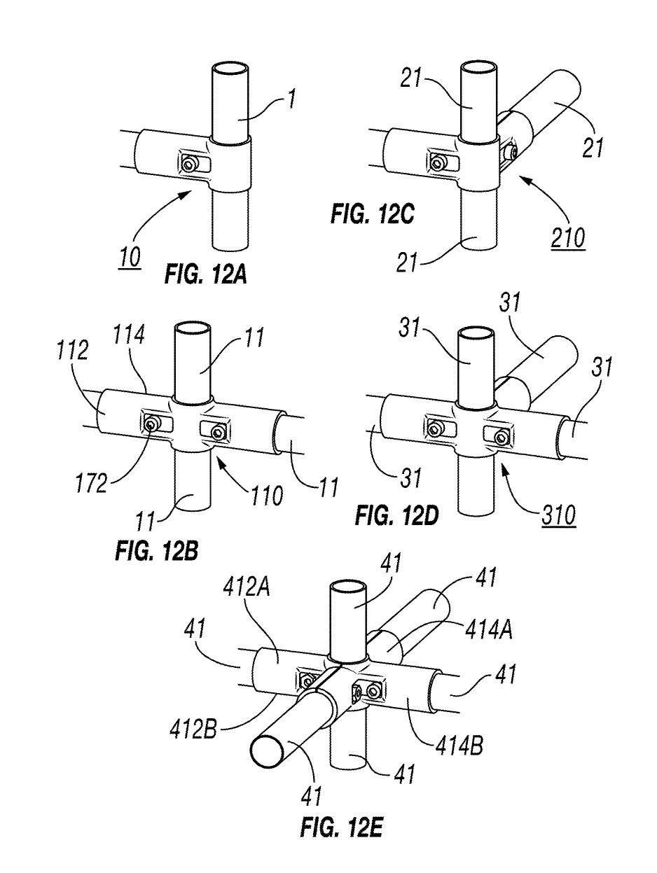

FIGS. 11 and 12 comparatively show portions of the connection system 10 described above along with other attachment systems designated in general by respective reference numbers 110, 210, 310, and 410 according to other aspects of the present disclosure. For clarity, only the first part 12 of the connection system 10 and a first part 112 of the connection system 110 are shown in FIG. 11. Also shown is the previously introduced material 70, the sleeve 71 (with slit 75), the bolts or screws 72, and the nuts 74 that may be used as described herein.

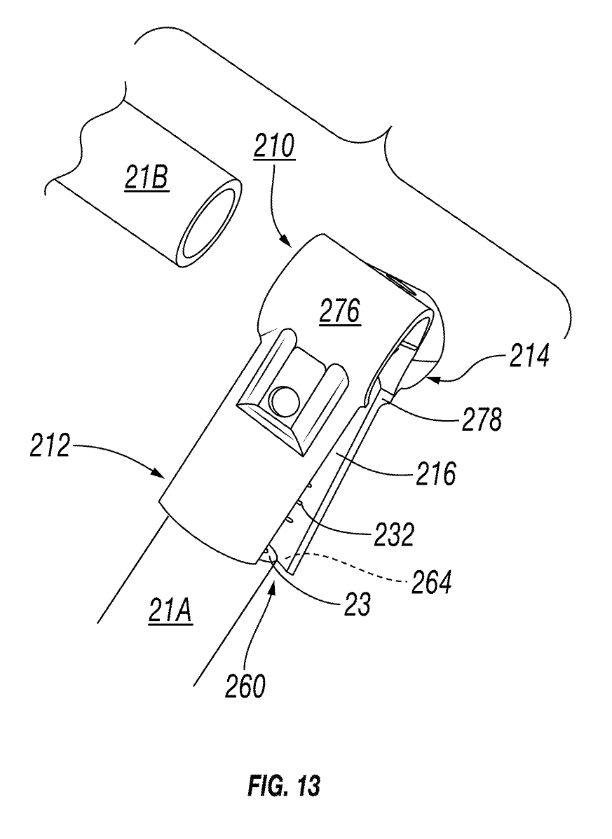

With particular reference to FIG. 11, the connection system 210 includes a first half 212 and a second half 214 that bend at substantially at right angles. As shown, the first half 212 is generally concave relative to a second half 214, which is generally convex relative to the first half 212. The first half 212 may include a first inner or interior wall or face 216, which is substantially concave or C-shaped in end view. Opposite the first face 216 is a first outer or exterior wall or face 218 having two recesses or pockets 240A, 240B and respective apertures or holes 228A, 228B. Approximately midway along the first half 212, there is a joint or transverse causeway 276 formed in which a conduit will be seated, as explained with respect to FIG. 13, below.

The second half 214 shown in FIG. 11 includes an interior wall 220 having apertures or holes 244A, 244B through which attachment components like the screws 72 are inserted to mate or connect the first half 212 with the second half 214. Also shown, a transverse shoulder or cradle 278 is complementary to the joint 276 such that, when coupled together, the joint 276 and the shoulder 278 form a raceway 266, and ridges 248 can grip a workpiece inserted therein. The shoulder 278 may have a cup-shape to complete the substantially cylindrical raceway 266 when mated with the joint 276 in this example, but as shown, the second half 214 and its shoulder 278 form an overall convex joining element relative to the joint 276.

Turning again to FIG. 12, the connection system 10 described above is shown attached to tube 1. For comparison, the attachment system 110 is also shown connected to a tube 11. The system 110 includes a first half 112 and a second half 114 that are oriented substantially parallel to each other for connecting three tubes 11. By way of further comparison, the attachment system 210 described in detail with respect to FIG. 11 also connects three tubes 21. In contrast, the connection system 310 enables connection of four or five pipes 31. By way of further example, the attachment system 410, which can include a first part 412A, a second part 412B, a third part 414A, a fourth part 414B are oriented substantially parallel to each other for connecting six tubes 41.

FIG. 13 shows the exemplary assembly procedure for the connection system 210. Here, the first part or clam shell 212 and the second part or clam shell 214 are being closed about a conduit 21A, which will be held in a proximal end 260 through a hole 264. More particularly, a terminal end 23 of the conduit 21A is inserted in the distal end 260 and the clam shells 212, 214 are closed over the terminal end 23. Some of the ribs 248 can be seen spaced along on the inner wall 216 for gripping the pipe 21. As shown, the shell 214 is relatively convex in relation to the relatively concave shell 212. As introduced in FIG. 11 above, when the clam shells 212, 214 are closed together, the causeway 276 and the shoulder 278 form a transverse passageway 280 for another pipe 21B.

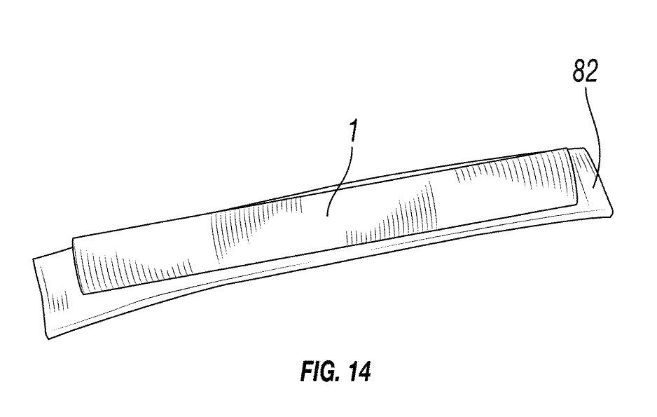

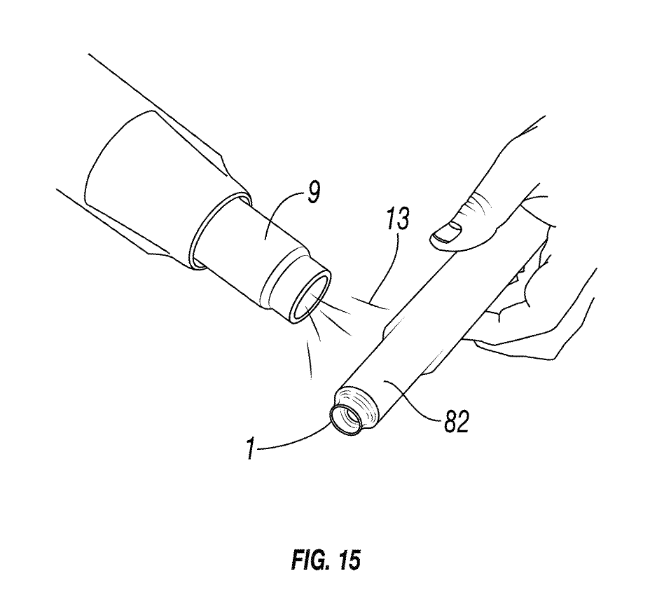

Turning to another aspect of the disclosure, FIGS. 14 and 15 shows shrink wrap, plastic film, or heat wrap 82 being placed over the EMT 1. Similar to the end-cap 70 described with respect to FIG. 5 above, the shrink wrap 82 can cover the EMT 1 to prevent injury or damage from sharp pipe edges, but the shrink wrap 82, which can be provided in different colors and textures, can also provide a visually appealing workpiece. Moreover, the shrink wrap 82 can provide additional gripping capability for the systems described herein. As FIG. 15 particularly shows, after the shrink wrap 82 is placed about the EMT 1, a hot air gun 9 is used to blow hot air 13 onto the wrap 82, which shrinks and form-fits around the pipe 1.

With reference now to FIG. 16 another aspect of the disclosure is shown in which a connecting system is designated in general by the reference number 510. In this embodiment, two parts or caps 512, 514 are shown separated. The first cap 512 may include a first inner or interior wall or face 516, which is substantially concave or C-shaped in end view. Opposite the first face 516 is a first outer or exterior wall or face 518, and the first face 516 may form a first cradle, cup, or raceway 524 having a first aperture or hole 528, a first stop, berm, or ledge 530, and a friction sheet or insert 582A. The aperture 528 is for insertion of an attachment mechanism, such as a hex bolt, Cotter key, pin, screw or the like. See, e.g., attachment mechanism 72, 74 in FIGS. 4 and 9A. The berm 530 will limit insertion of a tube or pipe 51, and the friction insert 582A will grip the tube 51 within the caps 512, 514. The friction insert 582A could be used with the connector 510 and the bare pipe 51, or the insert 582A could be removed and the pipe 51 could be wrapped as described with respect to FIG. 15 above. Moreover, the insert 582A can be used to customize, fit or size the connector 510 to accommodate different sizes and shapes of pipes or other workpieces. For instance, a thickness of the insert 582A could be increased to receive a smaller diameter pipe 51, or the insert 582A could be substantially rectangular to receive a square shaped workpiece (compare insert 582E receiving square beam 53 shown in phantom). By way of further example, the insert 582E could be relatively round or cup-shaped on one side to seat in the channel 526 and relatively square-shaped on an opposite side to receive the square beam 53. Of course, a complementary insert would be used in the part 514, or the part 514 could be formed with a square-shaped channel 542 to accommodate the workpiece 53. If the workpiece is substantially square on one side and substantially round on the other, then a combination of inserts 582A, 582E could be utilized.

As the example of FIG. 16 also shows, the first interior wall 516 may define a second cradle, cup, or raceway 526 formed, attached, or connected substantially at a right angle to the first raceway 524. Here, the raceway 526 includes a first terminal edge or end 534, and another friction insert 582B could be inserted in the raceway 526 in a manner similar to the insert 582A described above. A height 529 shows that the alternative insert 582E may be relatively taller or thicker than the insert 582B in order receive a smaller sized workpiece to adapt the raceway 526 to cradle the workpiece snugly. Likewise, the various inserts, such as the insert 582B and the alternative insert 582E could be thinner than shown to accommodate larger workpieces.

With particular reference now to the second half 514 shown in FIG. 16, an inner wall or face 520 has an opposing exterior or outer wall or face 522. The exemplary interior wall 520 is substantially concave, or C-shaped in end view and may form a third cradle, cup, or raceway 542 having a second aperture or hole 544 complementary to the first aperture 528, and a friction insert 582C similar to the insert 582A described above. Likewise, a friction insert 582D similar to the insert 582A can be inserted in a cross cradle 550 of the second half 514 to grip or accommodate a workpiece therein.

Also shown in FIG. 16, in addition or as an alternative to the apertures 528, 544 for receiving attachment mechanisms, the connector 510 may have a snap-fit system composed of one or more tab locks 572 and complementary receptacles 574 to lock the parts 512, 514 together. As shown, when the parts 512, 514 are aligned and closed together, the tabs 572 will slot or slide into their respective receptacles 574. For example, the tab 572 may have a detent 573 and the receptacle 574 may have a ledge or hook therein such that, when the tab 572 is slotted into the receptacle 574, the detent 573 catches the ledge within the receptacle 574 and springs into a locked position. A quick release button 586 can be pressed (as indicated by the double-headed arrow) to momentarily overcome a spring constant of the detent 573 and release the tab 572 from the receptacle 574 when a user desires to disassemble the components and remove the framework 51.

FIG. 17 shows another embodiment of a connection system, designated in general by element number 610, which may have sections or parts 612, 614. In this example, the sections 612, 614 are substantially identical. However, one of the sections 612, 614 could be longer than the other, for instance, such as to accommodate a desired bend in a workpiece, or one of the parts 612, 614 could be deeper than the other part and one part shallower. Moreover, one of the sections 612, 614 could be relatively rounder or cup-shaped and the other relatively more square in shape to accommodate a complementary shaped workpiece.

As shown in FIG. 17 the first section 612 may have a first inner or interior chamber, passageway, or trough 624, which is substantially concave or C-shaped in end view. The first chamber 624 may have a first fastener or latch 672 having a lip or catch 673A and may define a first stop, berm, or wall 630. As explained below, the berm 630 will limit axially insertion of a tube, pipe or other workpiece.

FIG. 17 also shows that the first section 612 may define a second cradle, cup, or raceway 626, which is formed, attached, or connected substantially orthogonally to the first chamber 624. In other words, the raceways 624, 626 may have different orientations, including but not limited to being substantially perpendicular to each other. Here, the raceway 626 includes a first terminal edge or puzzle-shaped end 634 for mating with the section 614 as explained below.

With particular reference to section 614 in FIG. 17, another cradle, cup, or raceway 642 may be provided with a second fastener 674 that may have with a second lip or catch 673B and may include or form a second stop, berm, or wall 631. The section 614 may also include another raceway 650 that terminates in a puzzle-shaped end 652 for mating with the complementary puzzle-shaped end 634 of the section 612. Although the fasteners 672, 674 are arranged in respective raceways 624, 642 in this example, the fasteners 672, 674 could alternatively extend from, for instance, the raceways 626, 650. Moreover, although separated, puzzle-shaped ends 634, 652 are shown by way of example, the ends 634, 652 could be hinged together such that only the fasteners 672, 674 have to be snapped together to secure a workpiece therebetween. See inset hinge variation 681 that may be used instead of the puzzle-shaped ends 634, 652.

As shown most clearly at the bottom of FIG. 17, in operation, when the sections 612, 614 are brought or closed together, the catch 673A of the fastener 672 will contact the catch 673B of the second fastener 674. Due the opposing angular formations of the exemplary catches 673A, 673B and spring constants of the fasteners 672, 674, when the sections 612, 614 pressed together, the catches 673A, 673B slide past each other and momentarily overcome the spring constants of the fasteners 672, 674 to mate the substantially mirror image parts 612, 614 about a workpiece. Although not limited to this exemplary operation, the sections 612, 614 might be attached first by bringing ends 634, 652 together and then by snapping the catches 673A, 673B together. To reverse operation or dissemble the connection system 610, apertures or windows 677A, 677B may be provided in one or both sections 612, 614 to release the fasteners 672, 674 from each other. For instance, respective slots or openings 679A, 679B may be provided in the fasteners 672, 674 to permit insertion of a tool through the windows 677A, 677B to hook the openings 679A, 679B and pull apart the fasteners 672, 674 and/or the fasteners 672, 674 may be disengaged by pushing them apart.

Although many of the exemplary connection systems have been described herein as having multiple parts, another variation of a connection system may be a one-piece connector having, for instance, a removable friction component as described herein. The unitary connection system might include a relatively large relief cut, hinged arrangement, or opening to fit about a pipe, which can be tightened using an attachment mechanism such as a bolt.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A connector for assembling components, the connector comprising:
a first part having a first proximal end and a first distal end, at least one of the first ends having a first non-linear edge;
a second part having a second proximal end and a second distal end, at least one of the second ends having a second non-linear edge complementary to the first non-linear edge for mating therewith, wherein, when the first part and the second part are mated, a cavity is formed therebetween to receive framework;
a friction-inducing component disposed in the cavity, the friction-inducing component being sizable to adjust a size of the mated first and second parts and configured to render the framework stationary; and
locking means to lock the first and second part together.

2. The connector as in claim 1, wherein the first and the second non-linear edges are puzzle-shaped.

3. The connector as in claim 1, wherein the friction-inducing component is selected from the group consisting of an end-cap, a shrink-wrap, a cavity coating, a friction insert, and combinations thereof.

4. The connector as in claim 1, wherein the friction-inducing component is an elastomeric material affixed within the cavity.

5. The connector as in claim 1, wherein the friction-inducing component has a thickness and a shape complementary to the framework such that the friction-inducing component sizes the cavity to complement the framework.

6. The connector as in claim 1, wherein the locking means is selected from the group consisting of a screw, a bolt, a snap-fit and combinations thereof.

7. A connector for assembling components, the connector comprising:
a first part having a first proximal end, a first distal end, and a concave joining element disposed therebetween;
a second part having a second proximal end, a second distal end, and a convex joining element disposed therebetween, wherein, when the first part and the second part are mated, a cavity is formed between concave and convex joining elements to receive a pipe;
a friction-inducing component disposed between the cavity and the pipe, the friction-inducing component being sizable to adjust a size of the cavity and configured to render the pipe stationary; and
locking means to lock the first and second part together.

8. The connector as in claim 7, wherein the friction-inducing component is selected from the group consisting of an end-cap, a shrink-wrap, a cavity coating, a friction insert, and combinations thereof.

9. The connector as in claim 7, wherein the locking means is selected from the group consisting of a screw, a bolt, and combinations thereof.

10. The connector as in claim 7, wherein the locking means includes a tab and a receptacle, the tab being configured to lock in the receptacle.

11. A connector for assembling components, the connector comprising:
a plurality of first parts each having a first proximal end and a first distal end;
a plurality of second parts each having a second proximal end and a second distal end, the second ends being complementary to the first ends for mating therewith wherein, when the first parts and the second parts are mated, respective cavities are formed therebetween to receive at least one workpiece therein;
a friction-inducing component disposed in at least one of the cavities, the friction-inducing component being configured to adjust a size of the mated first and second parts to press-fit the workpiece therebetween and to render the workpiece stationary; and
an attachment mechanism being configured to lock the plurality of first and second parts together.

12. The connector as in claim 11, wherein at least one of the first ends and at least one of the second ends have respective non-linear edges, the non-linear edges being substantially mirror images of each other and configured to hold the first and second ends together.

13. The connector as in claim 11, wherein at least one of the first ends and at least one of the second ends have respective puzzle-shaped ends, the puzzle-shaped ends being substantially mirror images of each other and configured to hold the first and second ends together.

14. The connector as in claim 11, wherein at least one of the first ends and at least one of the second ends are hinged together.

15. The connector as in claim 11, wherein at least one of the first ends and at least one of the second ends are disposed parallel to each other.

16. The connector as in claim 11, wherein at least one of the first ends and at least one of the second ends are disposed at an angle to each other.

17. The connector as in claim 11, wherein the friction-inducing component is selected from the group comprising shrink-wrap, an endcap, a sleeve and combinations thereof.

18. The connector as in claim 11, wherein the attachment mechanism is selected from the group comprising a bolt and nut combination, a tab and a receptacle combination, a plurality of latches, and combinations thereof.

19. The connector as in claim 18, wherein the attachment mechanism includes a button configured to release the tab from the receptacle.

20. The connector as in claim 11, further comprising an aperture to access the attachment mechanism.
